(19) United States
(12) Patent Application Publication
(10) Pub. No.: US 2013/0073940 A1
(43) Pub. Date: Mar. 21, 2013

(54) Data Reporting

(71) Applicant: Jeffrey Dean Honsowetz, Vancouver, WA (US)

(72) Inventor: Jeffrey Dean Honsowetz, Vancouver, WA (US)

(21) Appl. No.: 13/236,140

(22) Filed: Sep. 19, 2011

(51) Int. Cl. G06F 17/00

(52) U.S. Cl. 715/220

(57) ABSTRACT

Systems and methods are provided to import data into a range of cells in a spreadsheet application directly from data sources. In one example approach, a method comprises: during execution of a spreadsheet application on a computing device: importing data from a data source based on notation input, the notation input associated with an initial cell in the spreadsheet application; and associating the imported data with at least one other cell in the spreadsheet application, the at least one other cell different from the initial cell. For example, associating the imported data with at least one other cell in the spreadsheet application includes copying the data into the at least one other cell.

### BACKGROUND/SUMMARY

Spreadsheet applications may be used to access and format data, e.g., financial data, from data sources for use in generating various reports, e.g., financial reports. In some approaches, a notation, e.g. a formula, may be included in a cell in a spreadsheet in order to retrieve data from a data source to be displayed in that cell. Further, in some approaches, data from a data source may be imported into a proprietary database so that the spreadsheet application can access the data via a spreadsheet addin or via specialized formulas, for example.

However, the inventor herein has recognized issues with such approaches. For example, approaches which use a formula in a cell of a spreadsheet to retrieve data to that cell may perform slowly on large reports which retrieve data to a large number of cells where each cell in the large number of cells includes a formula. Further, such approaches may increase a user's difficulty in formatting retrieved data for presentation in a report. For example, on a standard report for a year trend, such approaches may have 12,000 separate formulas (e.g., 12 months×1000 rows) in 12,000 different cells.

As another example, in approaches which use a formula in a cell of a spreadsheet to retrieve data to that cell, the actual data may not be copied to the cell but instead query results may be displayed in that cell. Thus, in such approaches, the data may not be accessible for viewing by users that do not have access to the system or addin used to import the data. For example, when sharing a report with users who do not have access to a specialized addin or specialized formulas, reports may be stripped of the specialized formulas when shared with said users.

As another example, approaches which import data from a data source into a proprietary database so that the spreadsheet application can access the data may increase delays in accessing and updating data reduce accessibility to data, and increase resource drain. For example, when updating data in a report, a user may have to wait for updates to a proprietary database before data can be updated in the spreadsheet. As another example, different types of data, e.g. from different data sources, may have to be imported separately into the proprietary database before being accessed by the spreadsheet application.

In order to at least partially address these issues, systems and methods are provided to import data into a range of cells in a spreadsheet application from data sources. In one example approach, a method comprises: during execution of a spreadsheet application on a computing device: importing data from a data source based on notation input, the notation input associated with an initial cell in the spreadsheet application; and associating the imported data with at least one other cell in the spreadsheet application, the at least one other cell different from the initial cell. For example, associating the imported data with at least one other cell in the spreadsheet application includes copying the data into the at least one other cell.

In this way, the number of formulas used to create a report may be reduced. For example, a user may only use one formula to import data versus 12,000 different formulas as in the example given above, thus increasing speed and efficiency in accessing, updating, and formatting data in a report.

Further, in this approach an open data structure is utilized allowing a direct connection to any database or web service to retrieve data, thus reducing delays, reducing resource drain, and increasing versatility in report generation. Further still, in this approach, portability in sharing reports with users that do not have a specialized addin or formulas may be increased.

It should be understood that this summary is provided to introduce a selection of concepts in a simplified form that are further described below in the detailed description. This summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic illustration of an example computing environment in accordance with the disclosure.

FIG. 2 shows an example notation input in a spreadsheet application for importing data from a data source.

FIG. 3 shows an example spreadsheet data report as viewed by users that do not have access to the notation input.

FIG. 4 illustrates pulling data from a data source using notation input as assisted by dialogue boxes in a spreadsheet application.

FIG. 5 illustrates notation input as assisted by a dialogue box in a spreadsheet application.

FIG. 6 shows an example of providing an experience to a user of drilling down data by connecting two or more notations that display data.

FIG. 7 shows an example method for importing and updating data from a data source to a spreadsheet using notation input, including drilling to another notation.

FIG. 8 schematically shows a computing system in accordance with the disclosure.

### DETAILED DESCRIPTION

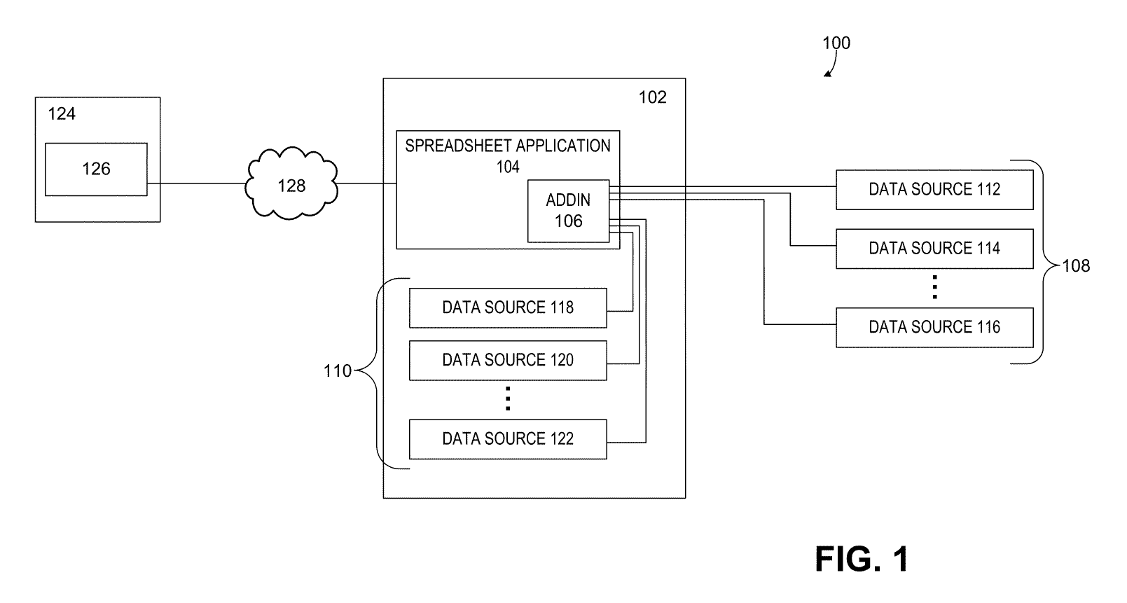

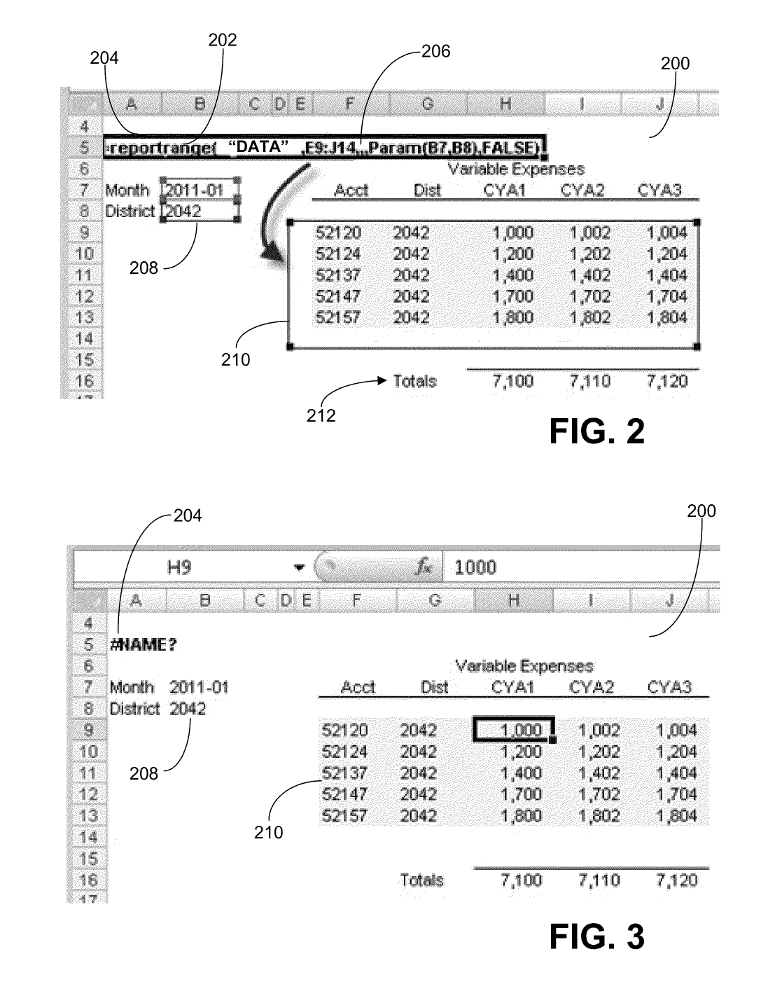

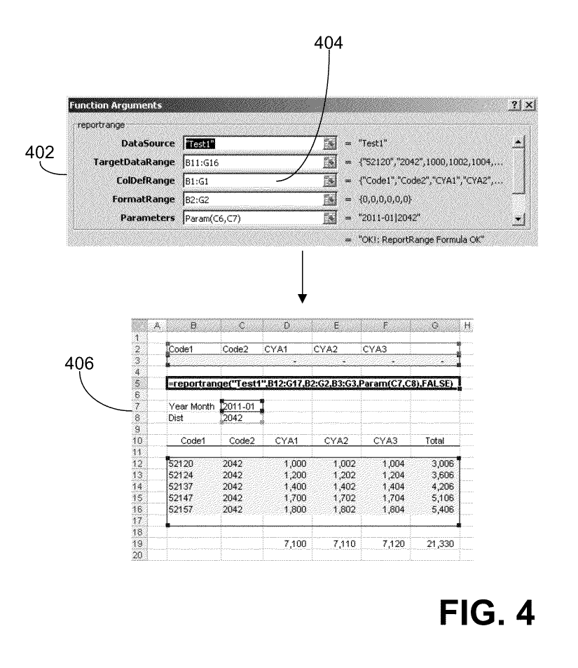

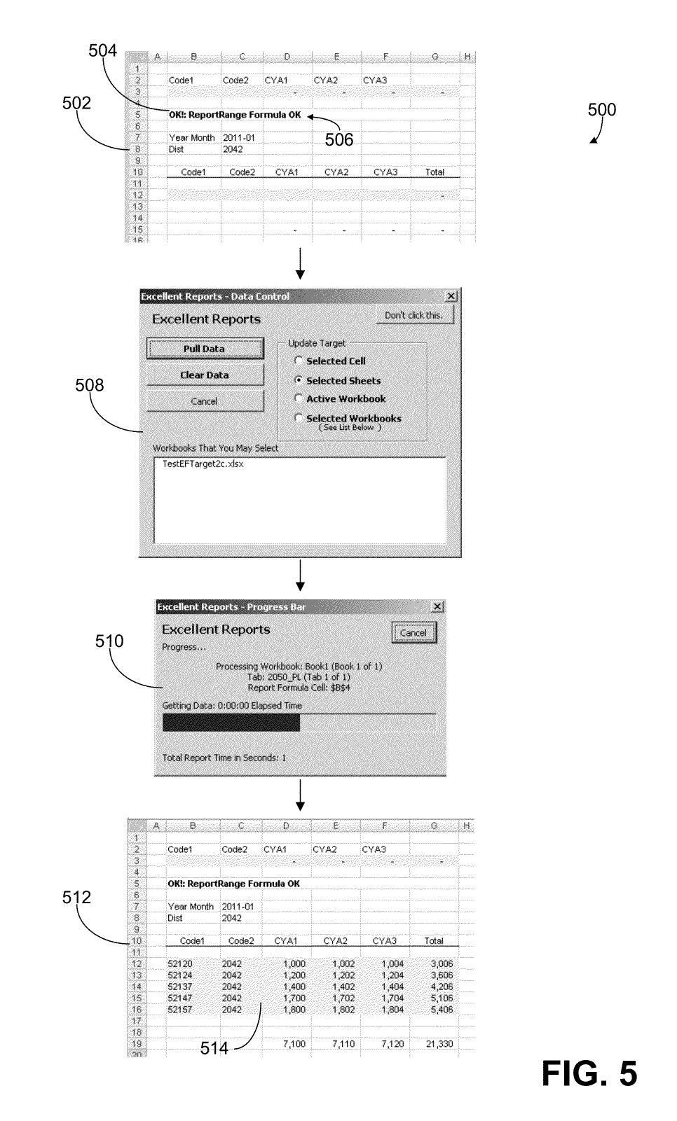

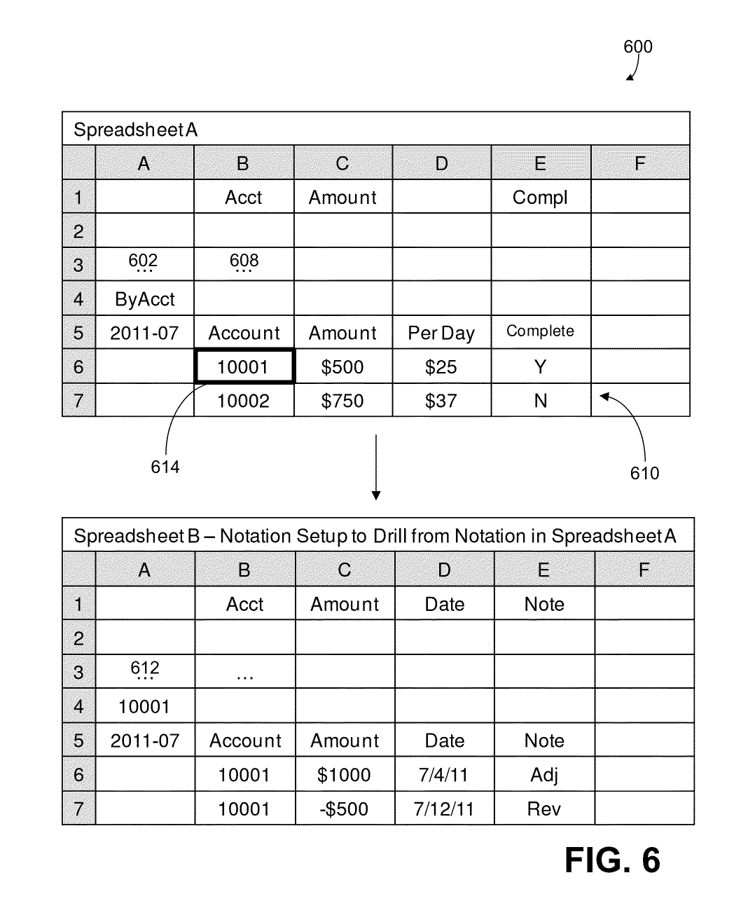

As remarked above, spreadsheet applications may be used to manage data, e.g., financial data, from data sources for use in generating various reports, e.g., financial reports. The present disclosure is directed to importing data into a range of cells in a spreadsheet application directly from data sources in a computing environment such as shown in FIG. 1. As shown in FIGS. 2 and 3, a notation input, e.g., a specialized formula, which specifies a range of cells where data will be imported and copied to, may be input into an initial cell of a spreadsheet. In some examples, such specialized formulas may be implemented via an addin or plug-in associated with the spreadsheet application and, as shown in FIGS. 4 and 5, various dialogue boxes within the spreadsheet application may assist a user in importing and updating data. In some examples, as illustrated in FIG. 6, notation inputs may be used to assist a user in performing drill downs on the data, permitting a user to easily access more detailed views of data of interest.

Turning to the figures, FIG. 1 shows an example computing environment 100 for importing and updating data directly from various data sources.

Computing environment 100 includes a computing device 102 configured to run a spreadsheet application 104. The spreadsheet application may be locally installed on the computing device or may be utilized through a web browser, for example. In some examples, the spreadsheet application may include an addin 106 or other suitable plug-in configured to confer additional functionality to spreadsheet application 104. However, in some examples, additional functionality as described herein may be built directly into the functionality of the spreadsheet application without any addin requirements. For example, addin 106 may provide the spreadsheet application with specialized functions accessible by a user of the spreadsheet application 104 to perform additional tasks within the spreadsheet application. For example, as described in more detail below herein, the addin 106 may provide various functions which can directly interface with data sources to import and format data into the spreadsheet application to generate data reports.

Data sources accessible by the spreadsheet application 104 via addin 106 may be any suitable source of data, e.g., databases, web data servers, and proprietary databases associated with programs such as Enterprise Resource Planning (ERP) Systems, Business Intelligence Solutions, Data Warehouses and transactional data systems, for example. In some examples, such data sources may be external to computing device 102; for example, a plurality of external data sources 108 including data source 112, 114, and 116 may be accessible to spreadsheet application 104 via addin 106. Data sources may also be internal to computing device 102, e.g., residing in a memory component of computing device 102. By way of example, a plurality of internal data sources 110 including data source 118, 120, and 122 may be accessible to spreadsheet application 104 via addin 106.

As described in more detail below, any suitable data source may be accessed by spreadsheet application 104 via addin 106 once a path to the data source is provided by a user of computing device 102. For example, an administrator may register a data source by providing a path or address to the data source and related credentials. In this way, data may be directly imported into spreadsheet application from a variety of different data sources or data servers.

In some examples, a spreadsheet application may be accessible by a client device 120 over a network 128 via an application 126 running on client device 120. For example, client device 124 may be a computing device running a browser which accesses the spreadsheet application via network 128. Network 128 may be any suitable network, e.g., the internet, an intranet, LAN, or WAN. In this example, computing device 102 may be configured to run as a network server providing spreadsheet application access to a plurality of different client devices. For example, computing device 102 may be a company server into which users log-on via terminal computers in order to access spreadsheet application 104. As another example, computing device 102 may be configured as a web server into which users of personal computers may remotely access spreadsheet application 104 via the internet.

As another example, spreadsheet application 104 may be configured to operate in a cloud computing environment, e.g., the application may be running over a plurality of servers and may be accessible by users of client devices over the internet. The client devices may be personal computing devices or mobile devices, e.g., cell phones, tablets, laptops, or the like. For example, a user may desire to manage data in the spreadsheet application via the cloud from a variety of different locales or networks.

The functionality of addin 106 may enable specialized notation input for managing data from data sources registered with the spreadsheet application 104 and may be used in addition to other tools and forms available in the spreadsheet application. For example, addin 106 may enable specific functions to be added to a spreadsheet in a spreadsheet application. Addin 106 may also refer to functionality described herein that is built within the spreadsheet application itself rather than provided by a separate addin. These specific functions may utilize various parameters to manage data from specified data sources. For example, such specialized functions may be used to import, update, format, and/or drill down data from various data sources. An example notation input in a spreadsheet application is shown in FIG. 2.

In particular, FIG. 2 shows an example spreadsheet page 200 in a spreadsheet application including notation input 202 used to import data from a data source. Notation input 202 is included in initial cell 204 (cell A5 in this example). In this example, notation input 202 is a formula called “reportrange” which may be entered into initial cell 204 by a user of the spreadsheet application, for example.

The notation input 202 includes a plurality of parameters 206. Parameters 206 may include any suitable parameters specifying actions to be performed by the spreadsheet application. In some examples, parameters 206 may be specific to a type of notation input entered into a spreadsheet and may depend on a data source accessed to import data. For example, data in a first data source may be managed using a first function that takes a first number of parameters whereas data in a second data source may be managed by a second function that takes a second number of parameters, where the first function is different from the second function and/or the first number of parameters is different from the second number of parameters. The number of parameters used in a function to manage data from a particular data source may be based on the structure of that data source or how the data source is setup by an administrator, for example. For example, the data source may include one or more fields and the notation input may specify a range which includes at least one of the one or more fields so that the data associated with those fields in the data source is imported into the spreadsheet. Such fields may be different for different data sources. In some examples, in the absence of a specification of a range, all fields may be included when importing data from the datasource.

As another example, the notation input may specify various formatting schemes to be applied to data imported into the spreadsheet. For example, specification of formatting may be performed by using a parameter in the notation input which specifies a range of cells in a spreadsheet to use as a formatting template for the imported data. For example, the formatting may include spreadsheet format settings as well as formulas and values to be inserted with imported data. As another example, specification of formatting may include a specified range to use as a formatting template to override formatting that is already present in the at least one other cell.

In the example shown in FIG. 2, notation input 202 specifies “DATA” as a data source, where “DATA” may be a key or identifier associated with a user-specified path to the data source, e.g., as stored in a lookup table in memory in the computing device on which the spreadsheet application is executing. In other examples, the notation input may include as a parameter the path itself to the data source, e.g., a network address, database connection string, or a path to a folder location of a data source on a computing device.

In some examples, notation input 202 may also reference other cells or inputs within the spreadsheet application besides the initial cell 204. Such other inputs may include parameters used in interacting with the data source, for example. For example, in FIG. 2, notation input 202 references other cells 208 which specify month and district data to be entered as parameters in the notation input. These parameters may be used to specify which data in the data source to import into the spreadsheet.

Notation input 202 may also specify a range of cells within the spreadsheet application where data from a data source is imported. For example, in FIG. 2 notation input 202 specifies the range 210 (cells E9:J14) to which data from the data source is imported. In some examples, the specified range of cells may include at least two rows so the data can be inserted from the first row and new rows added as needed underneath the first row. The bottom row in a specified range may be an anchor so that data analysis formulas, e.g., summation, can be used to operate on the entire range of data when data is imported and/or updated. In some examples, the width of the specified range may encompass the data requested, but can extend beyond that to capture formulas with the data that is inserted. By way of example, column G at 212 in FIG. 2 shows a formula that totals the three columns to the left of the specified data range 210.

In this way, the number of formulas used to create a report may be reduced. For example, on a standard report for a year trend, this approach may permit a user to import data into 12,000 different cells (12 months×1000 rows) using one formula in the initial cell rather than having 12,000 separate formulas in 12,000 different cells. Having one formula to import data to multiple different cells may increase speed and efficiency in accessing, updating, and formatting data in a report, and reduce resource load while retrieving live data, for example.

The data imported from the data source via notation input 202 is copied to each cell so that the data is viewable in the spreadsheet independent of the addin functionality. In this way, portability in sharing reports with users that do not have a specialized addin or formulas may be increased. For example, FIG. 3 shows how the spreadsheet page 200 shown in FIG. 2 may be viewed by a user that does not have access to the functionality conferred to the spreadsheet application by an addin. In this example, the notation input 202 has been removed or stripped in the initial cell 204 and replaced with a placeholder, e.g., “#NAME?.” However, since the data is actually copied to the cells in the range 210, the data is still visible to the user.

In some examples, an addin may enable functionality within the spreadsheet application to assist a user in entering specialized notations and parameters for the enabled functions. For example, various dialogue boxes, wizards, or other suitable assistance may guide a user in entering notation input and importing, formatting, and updating data from data sources.

FIG. 4 illustrates an example of how parameters may be input into notation input as assisted by a dialogue box in a spreadsheet application. For example, a dialogue box may be provided by the spreadsheet application and configured to guide a user to input parameters into notation input. The dialogue window or box at 402 may be presented to a user in response to input by the user. By way of example, dialogue box 402 shows an input form 404 within which a user may input desired parameters for a particular notation input or function. After the user inputs the parameters into the form, the dialogue box may be used by the spreadsheet application to import data based on the entered parameters in response to another user input into the spreadsheet application. For example, the user may enter “Ctrl Shift J” via a keyboard input into the spreadsheet application and the data will be imported or updated in the spreadsheet as shown at 406.

As another example of how an addin may enable functionality within the spreadsheet application to assist a user in entering specialized notations for managing data from a data source in a spreadsheet application, FIG. 5 illustrates steps 500 for pulling data from a data source using notation input as assisted by dialogue boxes in a spreadsheet application.

At 502, FIG. 5 shows a spreadsheet page which uses notation input to import data into a range of cells in the page. As shown in FIG. 5, after a user enters notation input into an initial cell, the spreadsheet application may be configured to check whether the syntax of the notation input is correct. For example, as shown at 506 in FIG. 6, the spreadsheet includes a notification that the formula entered into the initial cell 504 is correct. In this example, the notification is indicated by the spreadsheet application displaying “OK!” in the initial cell 504.

In order to run a report in this example, a user of the spreadsheet application may cause the spreadsheet application to import or update data based on the notation input by a suitable input into the spreadsheet application. For example, a user may select an option from a menu in the spreadsheet application or enter “Ctrl Shift J” via a keyboard input.

In response to the user input, the spreadsheet application may display dialog box 508. Dialogue box 508 displays various options that a user may choose in updating or importing data into the spreadsheet application. For example, dialogue box 508 provides options permitting the user to choose whether to import data to a single selected cell, selected sheets, or an entire workbook. Once the user clicks ‘Pull Data’ a progress window 510 may be displayed by the spreadsheet application as the data is pulled from a data source. The imported data is then copied into the cells in a specified range 514 in the spreadsheet page as shown at 512.

In some examples, users of data reports may desire to view some of the data in a more detailed manner. For example, a user may desire to drill down on existing data to view more details about a particular data entry. In some examples, a notation input may be used to assist a user in drilling down on data by connecting two different notations that pull data independently.

FIG. 6 shows an example of drilling down data using notation input. In FIG. 6 a first notation input or formula may be entered into an initial cell at 602 in spreadsheet A to import data into a range of cells 610 in spreadsheet A. Another spreadsheet, spreadsheet B, may include a second notation entered into an initial cell in spreadsheet B at 612 to import a more detailed view of a subset of the data imported into spreadsheet A. For example, the data in spreadsheet A includes account numbers and financial information associated with each account and spreadsheet B may include more detailed data associated with each account. In the example shown in FIG. 6, spreadsheet B shows detailed information associated with an account named 10001.

In order to provide drill down functionality to permit a user to easily view detailed data from spreadsheet A, a third notation may be included in a cell 608 in spreadsheet A. This third notation may reference the location of another spreadsheet to pull data from, in response to a user selection of that third notation, for example. In some examples, the third notation may enable linking functionality from one or more data entries so that, upon selection of a data entry, the spreadsheet application will open another spreadsheet and display the detailed data associated with that data entry. For example, as shown in FIG. 6, the entry for account 10001 at 614 in spreadsheet A may be configured by the third notation in cell 608 to enable a user to select the entry for account 10001 at 614 and bring up spreadsheet B which displays detailed data from account 10001.

In turn, spreadsheet B may also include notation input which enables drill downs to be performed on the data in spreadsheet B so that a user may be able to drill down or across the data as far as desired.

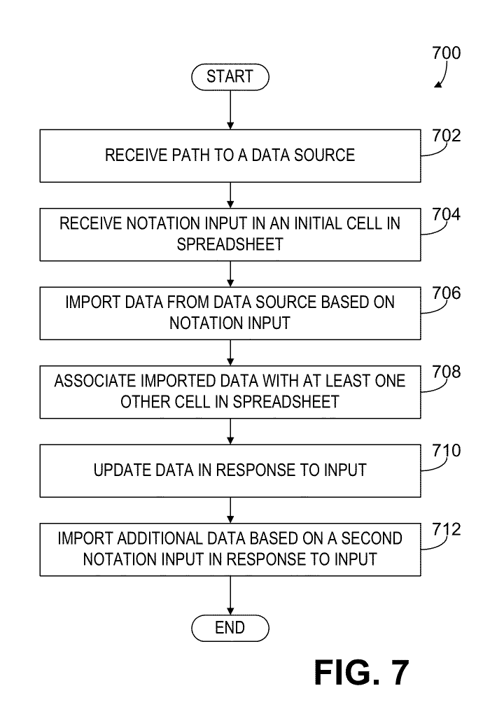

FIG. 7 shows an example method 700 for importing and updating data directly from data sources to a spreadsheet during execution of a spreadsheet application on a computing device, as described above.

At 702, method 700 includes receiving a path to a data source. For example, a user or administrator may set up a path to a data source in the spreadsheet application via an addin or through functionality available directly from the spreadsheet application. Such an addin may be installed by a user of a client device which accesses the spreadsheet application, for example.

In some examples, a key associated with the data source may be specified which references an actual path to the data source. Such a key may be used as a parameter in notation input to specify which data source to draw data from. For example, the key may be a name assigned to a specified path to a data source so that a user of a spreadsheet application may easily enter a specific data source into formulas by using the key. For example, the key may be a descriptor of a particular data source which assists the user in identifying what type of data source is to be referenced in notation input.

At 704, method 700 includes receiving a notation input in an initial cell in a spreadsheet application, where the notation input is associated with an initial cell in the spreadsheet application. For example, the notation input may be a formula specifying a range where data will go, said range including at least one other cell in the spreadsheet application. In some example, the range may be selected by a user via a suitable input device such as a mouse, keyboard, or touchscreen. For example, the user may select a target range by dragging a pointer using a mouse across multiple cells in a spreadsheet page to select a target range to import data into.

In some examples, the data in the data source may include one or more fields and the notation input may specify a range which includes at least one of the one or more fields. The fields in a data source may be provided by an administrator of a data source and may indicate different types of data contained in the data source. Further, the different fields in a data source may be associated with each other. For example, there may be a field called “account” which holds different account numbers and there may be other fields associated with the account field, e.g., an “amount” field which includes expenditure data associated with the accounts.

Since, different data sources may have different fields, when setting up a data source to be accessible by a spreadsheet application, a user may be provided with a list of possible fields of types of data and data associations which may be imported into the spreadsheet. The different fields may then be referenced in a formula to pull data of interest from the data source.

In some examples, the notation input may include a SQL request, connection string, or other suitable database query. Namely, a user may access data in a data source by entering a specific query into the initial cell to import data into a selected target range. For example, since SQL language is typically verbose, this text may be entered into a large range of the spreadsheet and then the notation can reference such text. The query may be of any suitable format and in any suitable query language recognized by the data source.

As described above, in some examples, the notation input may reference other inputs within the spreadsheet application, where the other inputs include parameters used in interacting with the data source. Further the notation input may include a specification of formatting to be used when the data is copied to the at least one other cell in the spreadsheet application. For example, a specification of formatting may include a specified range to use as a formatting template. However, in some examples, in the absence of a specification of formatting a default formatting range may be inferred as a formatting template.

At 706, method 700 includes importing data from a datasource or updating data to a data source based on the notation input. For example, data from the data source may be imported into the spreadsheet or existing data in the spreadsheet may packaged and sent to the data source to update data as specified by the data source.

At 708, method 700 includes associating the imported data with at least one other cell in the spreadsheet application, where the at least one other cell is different from the initial cell. For example, associating the imported data with at least one other cell in the spreadsheet application may include copying the data into the at least one other cell.

In some examples, associating the imported data with at least one other cell in the spreadsheet application may include displaying the notation input in the initial cell in a display of the spreadsheet, and displaying the imported data in the at least one other cell in the same display of the spreadsheet.

At 710, method 700 includes updating data in response to input. For example, data in the at least one other cell may be updated in response to an input received by the spreadsheet application. In some examples, the data in the data source may be updated based on changes made to the imported data in the at least one other cell in response to an input received by the spreadsheet application. In this way, if a user makes changes to existing imported data in a spreadsheet, those changes may be updated in the data source itself.

Further, in some examples, updating data in response to input may include performing drill downs on data as described above. For example, at 712, in response to an input received by the spreadsheet application, additional data may be imported from the data source based on a second notation input, where the additional data is related to the imported data.

In some embodiments, the above described methods and processes may be tied to a computing system including one or more computers. In particular, the methods and processes described herein may be implemented as a computer application, computer service, computer API, computer library, and/or other computer program product.

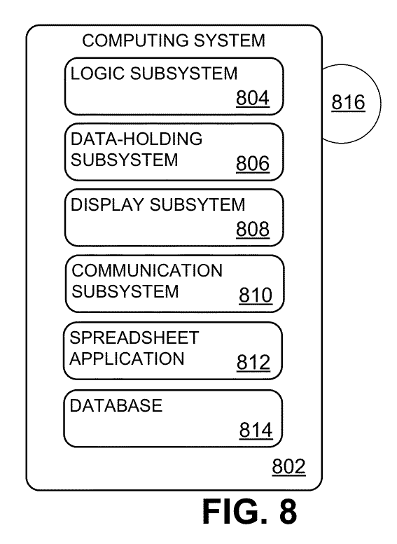

FIG. 8 schematically shows a nonlimiting computing system 802 that may perform one or more of the above described methods and processes. It is to be understood that virtually any computer architecture may be used without departing from the scope of this disclosure. In different embodiments, computing system 802 may take the form of a mainframe computer, server computer, desktop computer, laptop computer, tablet computer, home entertainment computer, network computing device, mobile computing device, mobile communication device, gaming device, etc.

Computing system 802 includes a logic subsystem 804 and a data-holding subsystem 806. Computing system 802 may optionally include a display subsystem 808, communication subsystem 810, and/or other components not shown in FIG. 8. Computing system 802 may also optionally include user input devices such as keyboards, mice, game controllers, cameras, microphones, and/or touch screens, for example.

Logic subsystem 804 may include one or more physical devices configured to execute one or more instructions. For example, the logic subsystem may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Data-holding subsystem 806 may include one or more physical, non-transitory, devices configured to hold data and/or instructions executable by the logic subsystem to implement the herein described methods and processes. When such methods and processes are implemented, the state of data-holding subsystem 806 may be transformed (e.g., to hold different data).

Data-holding subsystem 806 may include removable media and/or built-in devices. Data-holding subsystem 806 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 806 may include devices with one or more of the following characteristics: volatile, nonvolatile, dynamic, static, read/write, read-only, random access, sequential access, location addressable, file addressable, and content addressable. In some embodiments, logic subsystem 804 and data-holding subsystem 806 may be integrated into one or more common devices, such as an application specific integrated circuit or a system on a chip.

FIG. 8 also shows an aspect of the data-holding subsystem in the form of removable computer-readable storage media 816, which may be used to store and/or transfer data and/or instructions executable to implement the herein described methods and processes. Removable computer-readable storage media 816 may take the form of CDs, DVDs, HD-DVDs, Blu-Ray Discs, EEPROMs, and/or floppy disks, among others.

It is to be appreciated that data-holding subsystem 806 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

When included, display subsystem 808 may be used to present a visual representation of data held by data-holding subsystem 806. As the herein described methods and processes change the data held by the data-holding subsystem, and thus transform the state of the data-holding subsystem, the state of display subsystem 808 may likewise be transformed to visually represent changes in the underlying data. Display subsystem 808 may include one or more display devices utilizing virtually any type of technology. Such display devices may be combined with logic subsystem 804 and/or data-holding subsystem 806 in a shared enclosure, or such display devices may be peripheral display devices.

When included, communication subsystem 810 may be configured to communicatively couple computing system 802 with one or more other computing devices. Communication subsystem 810 may include wired and/or wireless communication devices compatible with one or more different communication protocols. As nonlimiting examples, the communication subsystem may be configured for communication via a wireless telephone network, a wireless local area network, a wired local area network, a wireless wide area network, a wired wide area network, etc. In some embodiments, the communication subsystem may allow computing system 802 to send and/or receive messages to and/or from other devices via a network such as the Internet.

In some examples, computing device 802 may include a spreadsheet application 812 which may be operatively connected to logic subsystem 804 and data-holding subsystem 806. Spreadsheet application 812 may further include an addin configured to confer additional functionality to the spreadsheet application as described above. Computing device 802 may also include at least one database 814 or other suitable data source which may be accessed by the spreadsheet application 812 to manage data contained in the database.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method comprising:
during execution of a spreadsheet application on a computing device:
importing data from a data source based on notation input, the notation input associated with an initial cell in the spreadsheet application; and
associating the imported data with at least one other cell in the spreadsheet application, the at least one other cell different from the initial cell.

2. The method of claim 1, wherein associating the imported data with at least one other cell in the spreadsheet application includes copying the data into the at least one other cell.

3. The method of claim 1, wherein associating the imported data with at least one other cell in the spreadsheet application includes displaying the notation input in the initial cell in a display of the spreadsheet, and displaying the imported data in the at least one other cell in the same display of the spreadsheet.

4. The method of claim 1, further comprising receiving the notation input in the initial cell in the spreadsheet application, where the notation input is a formula specifying a range where data will go, said range including the at least one other cell.

5. The method of claim 1, wherein the notation input references other inputs within the spreadsheet application, the other inputs including parameters used in interacting with the data source.

6. The method of claim 1, wherein the data source is a web service or a database and the computing device is connected to the data source via a network.

7. The method of claim 1, further comprising receiving a path to the data source and wherein the notation input includes a key specifying the data source, where the key is associated with a user-specified path to the data source.

8. The method of claim 1, further comprising receiving a path to the data source and wherein the notation input includes a user-specified path to the data source.

9. The method of claim 1, further comprising updating the data in the at least one other cell in response to an input received by the spreadsheet application, wherein updating the data includes importing updated data from the data source based on the notation input.

10. The method of claim 1, further comprising updating the data in the data source based on changes made to the imported data in the at least one other cell in response to an input received by the spreadsheet application.

11. The method of claim 1, wherein the notation input includes a specification of formatting to be used when the data is copied to the at least one other cell, where formatting includes spreadsheet format settings and formulas and values to be inserted with imported data.

12. The method of claim 11, wherein the specification of formatting includes a specified range to use as a formatting template to override formatting present in the at least one other cell.

13. The method of claim 1, wherein data in the data source includes one or more fields and the notation input specifies a range which includes at least one of the one or more fields or in the absence of a specification of a range inferring that all fields are to be included.

14. The method of claim 1, further comprising importing additional data from the data source based on a second notation input, and in response to a selection within the imported data from the first notation, directed by a third notation associating the first notation with the second notation.

15. A method of operating a computing device, the method comprising:
executing a spreadsheet application on the computing device;
while executing the spreadsheet application:
receiving notation input in an initial cell in the spreadsheet application, the notation input including a range of cells in the spreadsheet application, where the initial cell is not included in the range of cells;
importing data from a data source based on the notation input;
copying the data into the range of cells in the spreadsheet application, where the copied data includes a link to a location in the data source wherefrom the data was imported.

16. The method of claim 15, wherein the data source is a web service or a database and the computing device is connected to the data source via a network.

17. The method of claim 15, further comprising receiving a path to the data source and wherein the notation input includes a key specifying the data source, where the key is associated with a user-specified path to the data source and updating the data in the range of cells in response to an input to the spreadsheet application, wherein updating the data includes importing updated data from the data source based on the notation input.

18. A computing device, comprising:
a logic subsystem; and
a data holding subsystem comprising machine-readable instructions stored thereon that are executable by the logic subsystem to:
execute a spreadsheet application;
while executing the spreadsheet application:
receive notation input in an initial cell in the spreadsheet application;
import data from a data source based on the notation input; and
copy the data into at least one other cell in the spreadsheet application, the at least one other cell different from the initial cell.

19. The computing device of claim 18, wherein the notation input is a formula specifying a range where data will go, said range including the at least on other cell.

20. The computing device of claim 18, wherein the data holding subsystem comprising machine-readable instructions stored thereon that are executable by the logic subsystem is further configured to update the data in the at least on other cell in response to an input to the spreadsheet application, wherein updating the data includes importing updated data from the data source based on the notation input.
